(19) United States
(12) Patent Application Publication
(10) Pub. No.: US 2011/0127103 A1
(43) Pub. Date: Jun. 2, 2011

(54) POWER STEERING PUMP DRIVE

(75) Inventor: Jorg Nickl, Malter (DE)

(73) Assignee: VOITH PATENT GMBH, Heidenheim (DE)

(21) Appl. No.: 12/672,374

(22) PCT Filed: Mar. 5, 2008
(86) PCT No.: PCT/EP2008/001727

§ 371 Date: Feb. 5, 2010

(30) Foreign Application Priority Data
Aug. 9, 2007 (DE) 10 2007 037 687.3

(51) Int. Cl. B62D 5/06

(52) U.S. Cl. 180/417

(57) ABSTRACT

The invention relates to a power steering pump drive
with a single- or two-stage compressor unit;
the compressor unit comprises a housing, a piston, a cylinder, a connecting rod, a drive shaft and a crankshaft, further a power steering pump which comprises a housing and a piston;
the housing of the power steering pump is flange-mounted to the housing of the compressor unit;
the piston of the power steering pump is in drive connection with the crankshaft of the compressor unit.

The invention is characterized by the following features:
the power steering pump is disposed on the side of the crankshaft which is opposite of the piston of the compressor unit;
the drive connection between the crankshaft and the drive shaft of the power steering pump comprises a gear drive;
the gear drive is enclosed by the housing for the compressor unit.

The invention relates to a power steering pump drive.

The compressed-air network of a large-size vehicle, especially a bus, needs to fulfill a rising number of requirements. The activation of the brakes needs to be mentioned primarily. Further consumers of compressed air are the doors of the bus, the apparatus for inclining the entire bus for access aid and many more:

Piston compressors are used for generating compressed air. They are driven by the combustion engine of the vehicle. The compressor unit is flange-mounted to the combustion engine, which occurs in such a way that the crankshaft of the combustion engine and the crankshaft of the compressor extend coaxially. The piston and cylinder of the compressor unit are disposed in the built-in state generally above the crankshaft of the compressor.

The oil pressure required for auxiliary steering is generated by a separate unit, which is the power steering pump. In known embodiments, the power steering pump is driven directly via a yoke connection by the crankshaft of the compressor unit. The housing of the power steering pump is flange-mounted in axial alignment to the housing of the compressor unit. Such compressors are known for example from EP 1 650 434 A2 and EP 1 703 125 A2.

The assembly formed by the compressor unit and power steering pump is flange-mounted to the combustion engine. A moment thus acts upon the fastening flange between compressor unit and combustion engine.

The need for compressed air is exceptionally high in buses with a capacity of up to 200 passengers. The dimensions of the compressor unit are respectively large, especially in the axial direction, which means the direction of the longitudinal axis of the crankshaft. This leads to problems:

As a result of the large overall length of the assembly consisting of compressor unit and power steering pump as seen in the direction of the longitudinal axis of the crankshafts, a considerable tilting moment acts upon the fastening flange between the combustion engine and the compressor unit. It reaches such a magnitude that a secure connection between the mentioned assembly and the combustion engine is no longer achieved. This applies especially to the vibration acceleration moments of the combustion engine.

The continually growing demands placed on an increase in the air conveyance quantities of the compressor lead to a larger displacement of the compressor and thus to larger overall lengths of the compressor. It follows from this that the position of the power steering pump will move farther away from the fastening flange of the compressor on the motor in the case of previously used embodiments. The logical consequence is that the tilting moment M₁ of the fastening flange will become so large that a secure connection between the compressor and the engine is no longer given, especially also through the vibration acceleration moments of the engine.

It is a further disadvantage of the current embodiments that the speed and thus the oil conveyance flow of the power steering pump is linked in a rigid manner to the speed of the drive engine of the vehicle.

The invention is based on the object of arranging the assembly consisting of compressor unit and power steering pump in such a way that the disadvantages of the current embodiments, which are too high tilting moments on the flanged connection between compressor and motor and no speed variability of the power steering pump, are eliminated.

This object is achieved by the features of claim 1.

The following is achieved in this way:
The mentioned tilting moment which is generated by the assembly consisting of compressor unit and power steering pump is minimized. No impermissibly high forces will thus act upon the fastening flange between the combustion engine and the compressor unit.
The speed of the power steering pump is disconnected from the speed of the compressor unit. Different sets of gearwheels can be used for different applications, and speeds of the power steering pump which are adjusted to the respective requirements can be achieved.
Moreover, the overall length of the mentioned assembly is reduced, which is advantageous in many cases because the overall axial space is limited.

The invention is now explained in closer detail by reference to the drawings, which show in detail:

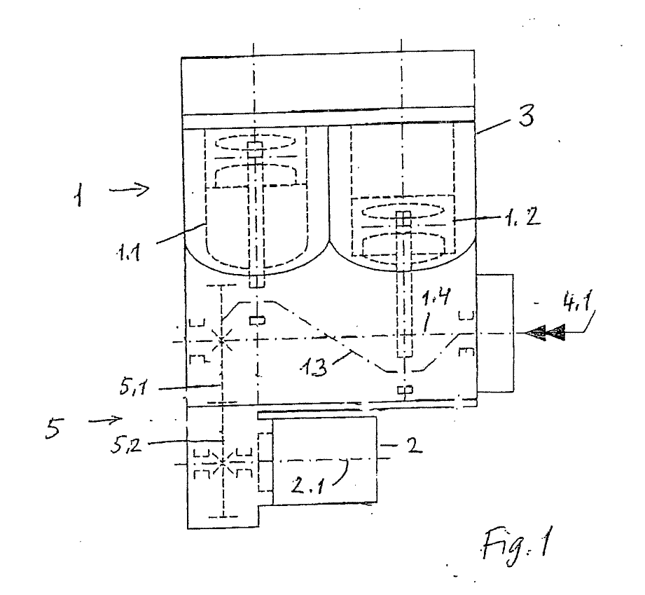

FIG. 1 shows a compressor unit with an integrated power steering pump according to the invention.

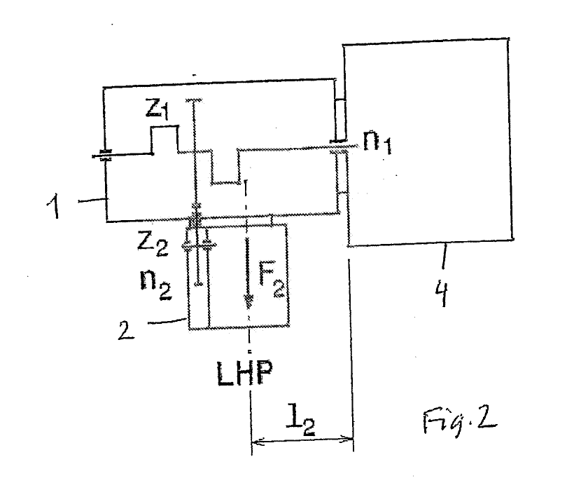

FIG. 2 shows a schematic view of a drive engine, a compressor unit and a power steering pump, again according to the invention.

The assembly shown in FIG. 1 comprises a compressor unit 1 and further a power steering pump 2. Both comprise a common housing 3.

The compressor unit 1 comprises two cylinders 1.1 and 1.2. Both cylinders 1.1 and 1.2 lie parallel next to one another and perform strokes which are parallel with respect to one another. The crankshaft 1.3 of the compressor unit 1 is driven by an engine 4 whose torque is illustrated by the double arrow 4.1, see FIG. 2. The fastening flange 6 is shown which carries the entire assembly.

The drive shaft 2.1 of the power steering pump 2 extends parallel to the longitudinal axis 1.4 of the compressor unit, but is offset in relation to the same. The axial length of the assembly is reduced in this way. As a result, the tilting moment which acts upon the fastening flange 6 is also smaller than in the state of the art.

FIG. 2 also shows an embodiment in accordance with the invention in a schematic view. The compressor unit 1 also comprises two cylinders in this illustration. One can also see engine 4. The indicated designations n₁ and n₂ mean the speeds of the compressor unit 1 or the power steering pump 2. These two speeds are independent of each other.

The following relations apply:

M₁=F₁×I₁

M₂=F₂×I₂

F₁=F₂

M₂=M₁×I₂/I₁

n₂/n₁=z₁/z₂

n₂=n₁×z₁/z₂

The following is achieved in detail with the invention:

$$\begin{matrix}{M}_{2} = {M}_{1} \times \frac{{l}_{2}}{{l}_{1}} \\ since \\ {l}_{1} > {l}_{2} ⇒ {M}_{2} < {M}_{1} . & 1 \\ {n}_{2} = {n}_{1} \times \frac{{z}_{1}}{{z}_{2}} . & 2\end{matrix}$$

so that n₂ is variable depending on the ratio

$$\frac{{z}_{1}}{{z}_{2}}$$

The wheel drive 5 can be arranged differently in the embodiment in accordance with the invention for different types of vehicles with different requirements and can thus be exchanged.

It is also possible to arrange the wheel drive 5 in such a way that the speed can be varied, so that the power steering pump works with different speeds in one and the same apparatus.

The gear drive 5 can be arranged as a bevel gear drive.

### LIST OF REFERENCE NUMERALS

1 Compressor unit
1.1 Compressor
1.2 Compressor
1.3 Crankshaft
1.4 Longitudinal axis
2 Power steering pump
2.1 Drive shaft
3 Housing
4 Engine
4.1 Torque
5 Gear drive
5.1 Spur gear
5.2 Spur gear
6 Fastening flange

1. A power steering pump drive for a motor vehicle, comprising a single- or two-stage compressor unit (1) which is driven by the engine of the motor vehicle and comprises a housing, at least one piston, at least one cylinder, a connecting rod and a crankshaft (1.3), and a power steering pump (2) with a housing and a piston, with the housing of the power steering pump (2) being connected with the housing of the compressor unit (1), and the piston of the power steering pump (2) being in drive connection with the crankshaft (1.3) of the compressor unit, characterized in that the power steering pump (2) is disposed on the side of the crankshaft (1.3) which is opposite of the piston of the compressor unit (1), the drive connection between the crankshaft (1.3) and the drive shaft (2.1) of the power steering pump (2) comprises a gear drive (5), and the gear drive (5) is enclosed by a common housing (3) for the compressor unit (1) and the power steering pump (2).

2. An apparatus according to claim 1, characterized in that the gear drive (5) is a spur gear drive and the axis of the drive shaft (2.1) of the power steering pump (2) extends parallel to the crankshaft (1.3) of the compressor unit (1).

3. An apparatus according to claim 1, characterized in that the gear drive (5) is a bevel gear drive and the axis of the drive shaft (2.1) of the power steering pump (2) extends under an angle in relation to the crankshaft axis.

4. An apparatus according to claim 1, characterized in that the gear drive (5) is variable in speed.
